(19) United States
(12) Patent Application Publication
(10) Pub. No.: US 2013/0309570 A1
(43) Pub. Date: Nov. 21, 2013

(54) POSITIVE ELECTRODE SLURRY COMPOSITION FOR LITHIUM SECONDARY BATTERY, LITHIUM SECONDARY BATTERY COMPRISING THE SAME AND METHOD OF MAKING THE LITHIUM SECONDARY BATTERY

(71) Applicants: Daesik KIM, Yongin-si (KR); Junkyu Cha, Yongin-si (KR); Hyeonseok Kim, Yongin-si (KR)

(72) Inventors: Daesik KIM, Yongin-si (KR); Junkyu Cha, Yongin-si (KR); Hyeonseok Kim, Yongin-si (KR)

(73) Assignee: Samsung SDI Co., Ltd., Yongin-si (KR)

(21) Appl. No.: 13/593,367

(22) Filed: Aug. 23, 2012

(30) Foreign Application Priority Data
May 15, 2012 (KR) 10-2012-0051683

(51) Int. Cl. H01M 4/02; H01M 4/525; H01M 4/60; H01M 4/58; H01M 4/62; H01M 4/505; H01M 4/04; H01M 4/485; H01M 4/587

(52) U.S. Cl. 429/213; 429/223; 429/221; 429/220; 427/126.6; 252/182.1; 252/500; 252/502; 252/512

(57) ABSTRACT

Provided are a positive electrode slurry composition for a lithium secondary battery, which can be prepared by an improved preparation method by preventing slurry from being gelled by adding an inorganic additive in preparing slurry of a nickel (Ni) based positive active material, a lithium secondary battery comprising the same and a method of making the lithium secondary battery. The positive electrode slurry includes a nickel (Ni) based positive active material; a binder; and an inorganic additive.

### CROSS-REFERENCE TO RELATED APPLICATIONS

This application claims the benefit of Korean Patent Application No. 10-2012-0051683 filed on May 15, 2012, the contents of which are incorporated herein by reference in their entirety.

### BACKGROUND

1. Field

Aspects of the present embodiments relate to a positive electrode slurry composition for a lithium secondary battery, a lithium secondary battery comprising the same and a method of making the lithium secondary battery. More particularly, aspects of the present embodiments relate to a positive electrode slurry composition for a lithium secondary battery, which can achieve large capacity of a battery by preventing slurry from being gelled by adding an inorganic additive in preparing slurry of a nickel (Ni) based positive active material, a lithium secondary battery comprising the same, and a method of making the lithium secondary battery.

2. Description of the Related Technology

As applications of lithium secondary batteries are extended from small-sized electronic devices to electric vehicles and power storage means, there are increasing demands for positive electrode materials for a secondary battery having improved safety, long cycle life, high energy density and high power properties.

In the lithium secondary battery, lithium composite oxide is generally used as a positive active material and examples thereof may include lithium cobalt oxide, lithium nickel oxide, lithium manganese oxide or lithium nickel cobalt manganese oxide. Slurry is prepared by mixing the positive active material with a binder, a conductive agent and a solvent. A positive electrode is manufactured by coating the slurry on a positive current collector, drying and pressing.

As a binder, polyvinylidene fluoride (PVdF) is generally used. When PVdF makes a contact with an alkali component such as hydroxide ion (OH—), hydrogen and fluorine are bonded with each other to carry out dehalogenation. Double bonds generated during dehalogenation may cause crosslinkage by oxygen or moisture, thereby resulting in gelation of the slurry. The gelation of slurry makes it difficult to uniformly coat the slurry on a current collector and lowers adhesion between particles or between particles and the current collector. Therefore, the safety and performance of battery may be lowered and the yield in the battery manufacturing process may be reduced.

### SUMMARY OF CERTAIN INVENTIVE ASPECTS

Aspects of the present embodiments provide a positive electrode slurry composition for a lithium secondary battery, which can achieve a large capacity of the battery by preventing slurry from being gelled by adding an inorganic additive in preparing slurry of a nickel (Ni) based positive active material, and a lithium secondary battery comprising the same and a method of making the lithium secondary battery.

According to aspects of the present embodiments, there is provided a positive electrode slurry composition for a lithium secondary battery, including a nickel (Ni) based positive active material; a binder; and an inorganic additive.

According to aspects of the present embodiments, there is provided a lithium secondary battery including a positive electrode manufactured using the positive electrode slurry, a negative electrode including a negative active material capable of intercalating/deintercalating lithium ions, and an electrolyte.

According to the present embodiments, slurry gelation can be prevented by adding an inorganic additive to a nickel-based positive active material slurry, thereby increasing the safety of a positive active material slurry composition and allowing the positive active material slurry composition to be stored for an extended period of time, ultimately improving a positive electrode manufacturing process. In addition, when the positive electrode is manufactured, the positive active material slurry can be uniformly coated on the current collector, and adhesion between particles or between particles and the current collector can be increased, thereby achieving a large capacity of battery and improving the positive electrode manufacturing process.

Additional aspects and/or advantages of the embodiments will be set forth in part in the description which follows and in part will be obvious from the description or may be learned by practice of the present embodiments.

### BRIEF DESCRIPTION OF THE DRAWINGS

The aspects, features and advantages of the present embodiments will be more apparent from the following detailed description in conjunction with the accompanying drawings, in which:

FIG. 1 illustrates a change in the viscosity of a positive active material slurry composition according to Comparative Example after 36 hours;

FIG. 2 illustrates a change in the viscosity of a positive active material slurry composition according to Example 1 after 36 hours; and

FIG. 3 is a graph illustrating rate discharge capacities of secondary batteries manufactured using positive active material slurry compositions according to Comparative Example and Examples 1 and 2.

### DETAILED DESCRIPTION OF CERTAIN INVENTIVE EMBODIMENTS

The present embodiments will now be described in detail with reference to example embodiments thereof.

The present embodiments relate to a positive electrode slurry composition for a lithium secondary battery, comprising a nickel (Ni) based positive active material, a binder and an inorganic additive.

### Inorganic Additive

Any inorganic additive can be used, which is capable of serving as an acid in the presence of a hydroxide ion (OH—) to neutralize the hydroxide ion and reduce a pH level, thereby preventing gelation of a positive electrode slurry.

The reaction mechanism of vanadium oxide (V₂O₅) is as follows

1) In acidic condition

V₂O₅+2HNO₃→2VO₂(NO₃)+H₂O

2) In basic condition

V₂O₅+6LiOH→2Li₃VO₄+3H₂O

Vanadium oxide (V₂O₅) serves as an acid in a basic condition and reduces a pH level.

According to an embodiment, the inorganic additive may be at least one selected from the group consisting of ZnO, TiO₂, SnO₂, Al₂O₃, In₂O₃, SiO₂, WO₃, and V₂O₅. In some embodiments, V₂O₅ is preferably used as the inorganic additive.

In some embodiments, the inorganic additive is from about 0.01 wt % to about 5 wt %. If the amount of the inorganic additive is less than about 0.01 wt %, the gelation preventing effect is low. If the amount of the inorganic additive is greater than about 5 wt %, discharge capacity is lowered, thereby deteriorating battery performance.

### Positive Electrode Slurry Composition

The positive electrode slurry composition according to the some embodiments includes a nickel (Ni) based positive active material, a binder and a solvent in addition to the inorganic additive. If necessary, the positive electrode slurry composition may further include a conductive agent, a filler and a viscosity adjusting agent.

The nickel (Ni) based positive active material includes a lithium metal oxide, which may be selected from the group consisting of materials represented by formulas (1) to (7):

LiₓNi_{1-y}M_{y}A₂ (1)

LiₓNi_{1-y}M_{y}O_{2-z}X_{z} (2)

LiₓNi_{1-y}Co_{y}O_{2-z}X_{z} (3)

LiₓNi_{1-y-z}Co_{y}M_{z}A_{α} (4)

LiₓNi_{1-y-z}Co_{y}M_{z}O_{2-α}X_{α} (5)

LiₓNi_{1-y-z}Mn_{y}M_{z}A_{α} (6)

LiₓNi_{1-y-z}Mn_{y}M_{z}O_{2-α}X_{α} (7)

wherein 0.9≦x≦1.1, 0≦y≦0.5, 0≦z≦0.5, 0≦α≦2, M is selected from the group consisting of Mg, Al, Co, K, Na, Ca, Si, Ti, Sn, V, Ge, Ga, B, As, Zr, Mn, Cr, Fe, Sr, V and rare-earth elements, A is selected from the group consisting of 0, F, S and P, and X is selected from the group consisting of F, S and P.

Any material capable of binding particles of the positive active material to each other or the positive active material to a current collector may be used as the binder. Representative examples of the binder may include, but are not limited to, polymers including polyvinylalcohol, carboxymethylcellulose, hydroxypropylcellulose, polyvinylchloride, carboxylated polyvinylchloride, polyvinylfluoride, and ethylene oxide, polyvinylpyrrolidone, polyurethane, polytetrafluoroethylene, polyvinylidene fluoride, polyethylene, polypropylene, styrene-butadiene rubber, acrylated styrene-butadiene rubber, and epoxy resin, nylon. In some embodiments, polyvinylidene fluoride can be used as the binder.

A nonaqueous solvent or an aqueous solvent may be used as the solvent. Examples of the nonaqueous solvent may include N-methyl-2-pyrrolidone (NMP), dimethylformamide, dimethylacetamide, N,N-dimethylaminoproylamine, ethyleneoxide, and tetrahydrofuran.

The conductive agent is used to impart conductivity to an electrode. Any electrically conductive material can be used as long as it does not cause a chemical change in the battery manufactured, and may be used in an amount of about 1-30 wt % based on the weight of electrode mixture. Examples of the conductive agent may include conductive materials including a carbon material such as natural graphite, artificial graphite, carbon black, acetylene black, ketjen black or carbon fiber, a metallic material such as metal powder or fiber of copper, nickel, aluminum or silver, a conductive polymer such as polyphenylene derivatives, or combinations thereof.

The filler is an auxiliary component for suppressing swelling of an electrode, and any fibrous material can be used as the filler without limitation, as long as it does not cause a chemical change in the battery manufacture. Examples of the filler may include an olefin based polymer such as polyethylene or polypropylene, or a fibrous material such as glass fiber or carbon fiber.

The viscosity adjusting agent is used to adjust the viscosity of electrode mixture to facilitate a mixing process of the electrode mixture and a coating process thereof on a current collector, and may be added up to about 30 wt % based on the total weight of the electrode mixture. Examples of the viscosity adjusting agent may include, but are not limited to, carboxymethylcellulose, and polyvinylidene fluoride. In some cases, a solvent used in preparing the positive electrode slurry may also serve as the viscosity adjusting agent.

### Lithium Secondary Battery

The present embodiments also provide a lithium secondary battery including a positive electrode manufactured using a positive electrode slurry composition prepared by mixing a nickel (Ni) based positive active material, a binder, an inorganic additive, and/or a conductive agent dissolved in a solvent; a negative electrode including a negative active material capable of intercalating/deintercalating lithium ions; a separator interposed between the positive electrode; and the negative electrode; and an electrolyte.

The positive electrode may be manufactured by forming slurry by dispersing the nickel (Ni) based positive active material, the binder, the inorganic additive and/or the conductive agent in the solvent, and coating the slurry on a positive current collector, followed by drying and pressing.

As the positive current collector, a metal such as aluminum, copper, nickel, silver or stainless steel, and metal alloys thereof. Aluminum or an aluminum alloy may be generally used as the positive current collector. The positive current collector is generally formed to a thickness of about 3 to about 500 μm.

The negative electrode includes a negative active material capable of intercalating/deintercalating lithium ions. The negative electrode may be manufactured by preparing a slurry composition by dispersing the negative active material, a binder and/or a conductive agent in a solvent and coating the slurry composition on a negative current collector.

The negative active material may include at least one selected from the group consisting of materials capable of reversibly intercalating/deintercalating lithium, metallic materials alloyable with lithium, and mixtures thereof, or a combination of two or more of these materials. Examples of the materials capable of reversibly intercalating/deintercalating lithium may include artificial graphite, natural graphite, graphitized carbon fiber, graphitized mesocarbon microbeads, fullerene and amorphous carbon. Examples of the amorphous carbon may include hard carbon, cokes, mesophase carbon microbead (MCMB) sintered at about 1500° C. or less, or mesophase carbon fiber (MPCF). In addition, examples of the metallic materials alloyable with lithium may include at least one selected from the group consisting of Al, Si, Sn, Pb, Zn, Bi, In, Mg, Ga, Cd and Ge. These metallic materials may be used alone or in alloys. In addition, the metal may be used as a composite material mixed with a carbon material.

The negative electrode is manufactured by coating a negative electrode slurry prepared by mixing and dispersing negative electrode mixture in a solvent on a negative electrode current collector, followed by drying and pressing.

A nonaqueous solvent or an aqueous solvent may be used as the solvent. Examples of the nonaqueous solvent may include N-methyl-2-pyrrolidone (NMP), dimethylformamide, dimethylacetamide, N,N-dimethylaminoproylamine, ethyleneoxide, and tetrahydrofuran.

Examples of the negative current collector may include punched metal, xpunched metal, gold foil, foamed metal, metal fiber sintered network, nickel foil, or copper foil.

The binder and the conductive agent for the negative active material slurry may be the same materials as those for the positive active material slurry.

The separator prevents an electric short circuit between the positive electrode and the negative electrode and provides for a movement passage of lithium ions. Examples of the separator may include a polyolefin based polymer film such as polypropylene, polyethylene, polyethylene/polypropylene, polyethylene/polypropylene/polyethylene, polypropylene/polyethylene/polypropylene, or a multi-layered film thereof, a microporous film, or woven or nonwoven fabric. In addition, a film having a highly stable resin coated on a porous polyolefin film may also be used. When a solid electrolyte such as a polymer is used as the electrolyte, it may also serve as the separator.

The electrolyte may include a lithium salt and a nonaqueous organic solvent and may further include additives for improving charge/discharge characteristics or preventing over-charge.

The lithium salt functions as a lithium ion source to allow the lithium battery to operate, and the nonaqueous organic solvent may serve as a medium to allow ions participating in electrochemical reactions of battery to move.

Examples of the lithium salt may include one or more types of materials selected from the group consisting of LiPF₆, LiBF₄, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlO₄, LiAlCl₄, LiCl and LiI. The lithium salt may be used in a concentration ranging from 0.6 to 2.0 M, more preferably in a concentration ranging from 0.7 to 1.6 M. If the concentration of the lithium salt is less than 0.6 M, the electric conductivity of electrolyte may be lowered, thereby deteriorating the performance of electrolyte. On the other hand, if the concentration of the lithium salt is greater than 2.0 M, the viscosity of electrolyte may increase, thereby lowering mobility of lithium ions.

As the nonaqueous organic solvent, carbonate, ester, ether or ketone may be used alone or in combination. Examples of the carbonate may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and butylene carbonate (BC), examples of the ester may include γ-butyrolactone (GBL), n-methylacetate, n-ethyl acetate, and n-propyl acetate, and examples of the ether may include dibutyl ether, but not limited thereto.

Among the nonaqueous organic solvents, carbonate-based solvents are preferably used in combination of cyclic carbonate and chain carbonate. In this case, cyclic carbonate and chain carbonate are preferably mixed in a volume ratio of about 1:1 to about 1:9. Within the volume ratio stated above, desirable performance of electrolyte may be demonstrated.

The nonaqueous organic solvent may further include an aromatic hydrocarbon based organic solvent. Specific examples of the hydrocarbon based organic solvent may include benzene, fluorobenzene, bromobenzene, chlorobenzene, cyclohexylbenzene, isopropylbenzene, n-butylbenzene, octylbenzene, toluene, xylene, or mesitylene, which may be used alone or in combination.

In the electrolyte including the aromatic hydrocarbon based organic solvent, carbonate solvent and the aromatic hydrocarbon based organic solvent may be mixed in a volume ratio of about 1:1 to about 30:1. Within the volume ratio stated above, desirable performance of electrolyte may be demonstrated.

The following Examples further illustrate the present embodiments in detail, but are not to be construed to limit the scope thereof.

### Comparative Example 1

30 g of Ecopro NCA020 (EcoPro Ltd.) as a positive active material, 10.42 g of polyvinylidene fluoride (solef 6020, 6% binder solution) as a binder, and 0.63 g of Denka Black as a conductive agent were mixed in a weight ratio of 96:2:2, dispersed in N-methyl-2-pyrrolidone (NMP) to prepare positive electrode slurry.

### Example 1

Positive electrode slurry was prepared in the same manner as in Comparative Example 1, except that 0.01 wt % of V₂O₅ as an inorganic additive was added in preparing the positive electrode slurry.

### Example 2

Positive electrode slurry was prepared in the same manner as in Comparative Example 1, except that 0.03 wt % of V₂O₅ as an inorganic additive was added in preparing the positive electrode slurry.

### Example 3

Positive electrode slurry was prepared in the same manner as in Comparative Example 1, except that 0.05 wt % of V₂O₅ as an inorganic additive was added in preparing the positive electrode slurry.

### Example 4

Positive electrode slurry was prepared in the same manner as in Comparative Example 1, except that 0.01 wt % of V₂O₅ as an inorganic additive was added in preparing the positive electrode slurry.

### Example 5

Positive electrode slurry was prepared in the same manner as in Comparative Example 1, except that 0.5 wt % of V₂O₅ as an inorganic additive was added in preparing the positive electrode slurry.

### Example 6

Positive electrode slurry was prepared in the same manner as in Comparative Example 1, except that 1.0 wt % of V₂O₅ as an inorganic additive was added in preparing the positive electrode slurry.

### Example 7

Positive electrode slurry was prepared in the same manner as in Comparative Example 1, except that 2.0 wt % of V₂O₅ as an inorganic additive was added in preparing the positive electrode slurry.

### Example 8

Positive electrode slurry was prepared in the same manner as in Comparative Example 1, except that 0.01 wt % of WO₃ as an inorganic additive was added in preparing the positive electrode slurry.

### Example 9

Positive electrode slurry was prepared in the same manner as in Comparative Example 1, except that 0.03 wt % of WO₃ as an inorganic additive was added in preparing the positive electrode slurry.

### Example 10

Positive electrode slurry was prepared in the same manner as in Comparative Example 1, except that 0.05 wt % of WO₃ as an inorganic additive was added in preparing the positive electrode slurry.

### Example 11

Positive electrode slurry was prepared in the same manner as in Comparative Example 1, except that 0.1 wt % of WO₃ as an inorganic additive was added in preparing the positive electrode slurry.

### Example 12

Positive electrode slurry was prepared in the same manner as in Comparative Example 1, except that 0.5 wt % of WO₃ as an inorganic additive was added in preparing the positive electrode slurry.

### Example 13

Positive electrode slurry was prepared in the same manner as in Comparative Example 1, except that 1.0 wt % of WO₃ as an inorganic additive was added in preparing the positive electrode slurry.

### Example 14

Positive electrode slurry was prepared in the same manner as in Comparative Example 1, except that 2.0 wt % of WO₃ as an inorganic additive was added in preparing the positive electrode slurry.

### Manufacture of Battery

Each of positive electrode slurry compositions prepared in Examples and Comparative Example was cast an aluminum thin film (15 micrometers), dried in a 120° C. vacuum oven and pressed, thereby manufacturing a positive electrode. A coin full cell type battery was manufactured using a negative electrode having copper (8 micrometers) coated with a negative active material (graphite, KPT), an electrolyte (1.15M LiPF₆ EC/EMC=3/7) and a separator (Asahi Al, 18 micrometers). Rate discharge capacity tests were carried out at upper and lower limit charge voltages of 4.2 V and 3.0 V with charged coin full cell type batteries.

### Experimental Example 1

### Precipitation Over Time

The positive electrode slurries prepared in Examples and Comparative Example were left to stand in the air to observe viscosity changes over time, and viscosity values were obtained using AR-G2 rheometer as viscosity measurement equipment. The observation results are listed in Tables 1 and 2.

TABLE 1
Viscosity Change over Time (Hr) at Shear rate (1/s) = 4

| | Positive | | | | | | | | |
|---|---|---|---|---|---|---|---|---|---|
| | active | | Inorganic additive | | | | Change over Time | | |
| | material | Binder | V₂O₅ | | WO₃ | | 0 h | 6 h | 36 h |
| Comparative | Ecopro | Solef | | | | | 1.62(◯) | 1.47(◯) | 55.69(X) |
| Example | NCA020 | 6020 | | | | | | | |
| Example 1 | Ecopro | Solef | 0.01 | wt % | | | 1.31(◯) | 1.34(◯) | 1.57(◯) |
| | NCA020 | 6020 | | | | | | | |
| Example 2 | Ecopro | Solef | 0.03 | wt % | | | 1.15(◯) | 1.98(◯) | 1.61(◯) |
| | NCA020 | 6020 | | | | | | | |
| Example 3 | Ecopro | Solef | 0.05 | wt % | | | 2.45(◯) | 2.03(◯) | 0.82(◯) |
| | NCA020 | 6020 | | | | | | | |
| Example 4 | Ecopro | Solef | 0.1 | wt % | | | 2.48(◯) | 2.18(◯) | 0.99(◯) |
| | NCA020 | 6020 | | | | | | | |
| Example 5 | Ecopro | Solef | 0.5 | wt % | | | 2.52(◯) | 2.15(◯) | 0.85(◯) |
| | NCA020 | 6020 | | | | | | | |
| Example 6 | Ecopro | Solef | 1.0 | wt % | | | 2.26(◯) | 2.03(◯) | 0.82(◯) |
| | NCA020 | 6020 | | | | | | | |
| Example 7 | Ecopro | Solef | 2.0 | wt % | | | 2.43(◯) | 2.12(◯) | 0.88(◯) |
| | NCA020 | 6020 | | | | | | | |
| Example 8 | Ecopro | Solef | | | 0.01 | wt % | 2.48(◯) | 2.15(◯) | 0.94(◯) |
| | NCA020 | 6020 | | | | | | | |
| Example 9 | Ecopro | Solef | | | 0.03 | wt % | 2.41(◯) | 2.03(◯) | 0.88(◯) |
| | NCA020 | 6020 | | | | | | | |
| Example 10 | Ecopro | Solef | | | 0.05 | wt % | 2.46(◯) | 2.13(◯) | 0.85(◯) |
| | NCA020 | 6020 | | | | | | | |
| Example 11 | Ecopro | Solef | | | 0.1 | wt % | 2.42(◯) | 2.08(◯) | 0.87(◯) |
| | NCA020 | 6020 | | | | | | | |
| Example 12 | Ecopro | Solef | | | 0.5 | wt % | 2.56(◯) | 2.16(◯) | 0.88(◯) |
| | NCA020 | 6020 | | | | | | | |
| Example 13 | Ecopro | Solef | | | 1.0 | wt % | 2.52(◯) | 2.10(◯) | 0.94(◯) |
| | NCA020 | 6020 | | | | | | | |
| Example 14 | Ecopro | Solef | | | 2.0 | wt % | 2.49(◯) | 2.17(◯) | 0.96(◯) |
| | NCA020 | 6020 | | | | | | | |

Viscosity (Pa, s)
(◯): No change
(X): Gelation

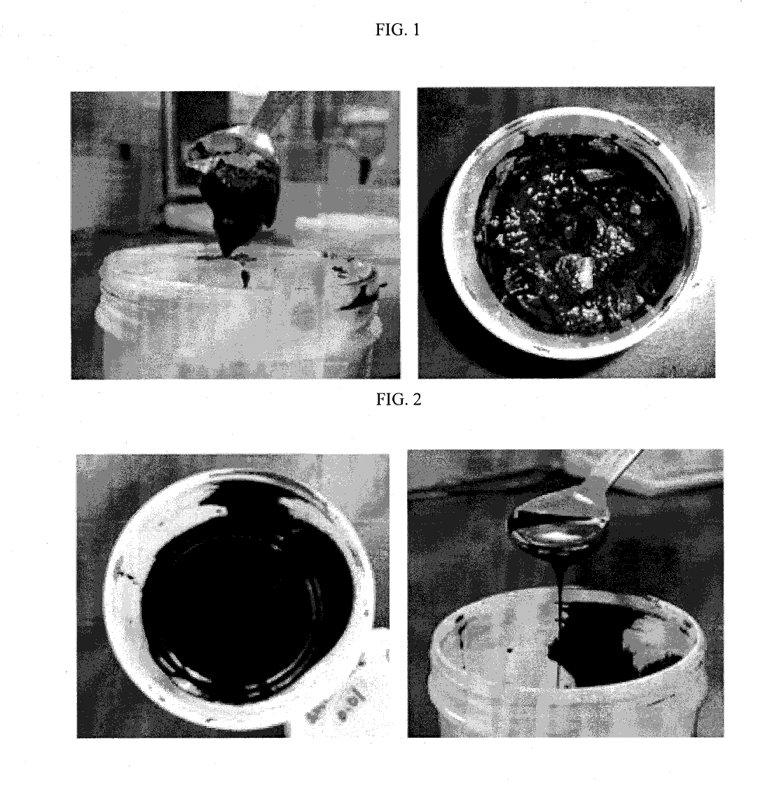

As confirmed from Table 1, the positive electrode slurry compositions each including the inorganic additive according to the present embodiments demonstrated gradually reducing or not substantially changing viscosity values. However, the positive electrode slurry composition without the inventive inorganic additive, like in Comparative Example, underwent an increase in the viscosity, resulting in gelation. This finding can also be confirmed from FIGS. 1 and 2.

As shown in FIG. 2, the positive electrode slurry including the inventive inorganic additive had a viscosity high enough to flow even after the passage of 36 hours. However, as shown in FIG. 1, the positive electrode slurry not including the inventive inorganic additive may be gelled, so that it does not flow, as confirmed by naked eye. Therefore, it is understood that the inorganic additive according to the present embodiments can prevent gelation of the positive electrode slurry composition.

In making a positive electrode, a positive active material composition is generally left to stand for a predetermined period of time. In this case, even after a prolonged period of time, gelation of the positive active material composition according to the present embodiments can be prevented and the positive electrode can be manufactured using the same. However, the positive active material composition prepared in Comparative Example experiences gelation within a short time. Thus, if coating of the slurry composition is not performed immediately after preparing the slurry, it may be impossible to make an electrode. Therefore, it is understood that the positive electrode manufacturing process can be greatly improved by using the positive electrode slurry composition according to the present embodiments.

### Experimental Example 2

### Evaluation of Battery Performance

2016 coin full cell type batteries manufactured using the positive electrode slurry active materials prepared in Examples and Comparative Example were subjected to charge/discharge tests. First, battery performance was evaluated by performing two cycles of formation charge/discharge tests process and one cycle of standard test at formation charge/discharge of 0.1 C/0.1 C, standard charge/discharge current density of 0.2 C/0.2 C, a final charge voltage of 4.2 V (Li/graphite), and a final discharge voltage of 3.0 V (Li/graphite). Thereafter, charge/discharge tests by rate were performed at 0.2 C/0.5 C (charge/discharge), 0.2 C/1.0 C (charge/discharge), 0.2 C/2.0 C (charge/discharge), 0.2 C/3.0 C (charge/discharge), 0.2 C/5.0 C (charge/discharge), and 0.2 C/7.0 C (charge/discharge). After performing discharge test by rate, 0.2 C discharge test was additionally performed at 1.0 C-7.0 C.

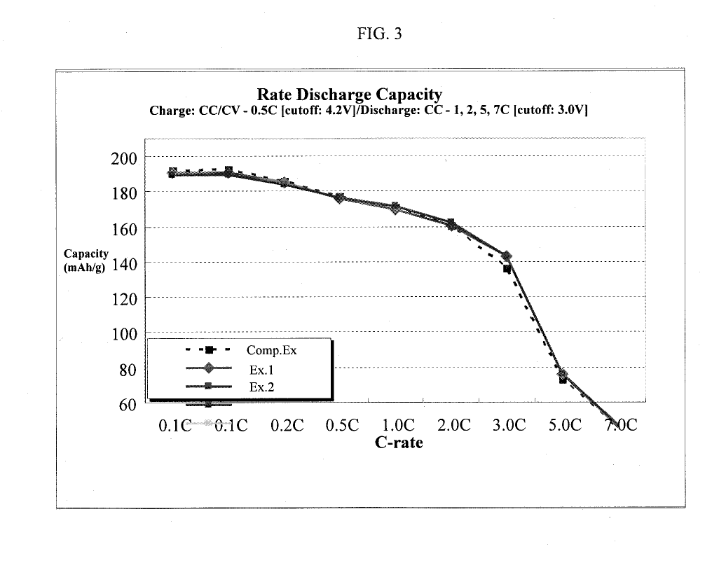

Table 2 and FIG. 3 show the evaluation results of battery performance in Comparative Example, Examples 1 and 2.

TABLE 2
Comparison of Rate Discharge Capacity values

| | | | | Discharge |
|---|---|---|---|---|
| | | Inorganic | | Capacity |
| | | additive | 0.2 C DCH | Difference |
| | Active material | (V2O5) | (mAh/g) | (mAh/g) |
| Comparative | Ecopro NCA020 | | 186.1 | |
| Example | | | | |
| Example 1 | Ecopro NCA020 | 0.01 wt % | 185.1 | −1.0 |
| Example 2 | Ecopro NCA020 | 0.05 wt % | 183.8 | −2.3 |

As confirmed from Table 2 and FIG. 3, when the battery was manufactured using the positive electrode slurry composition including the inorganic additive according to the present embodiments, a discharge reduction, which may be generally caused by adding an additive, was not considerable even if the additive was included in the positive electrode slurry composition.

Therefore, since the inorganic additive according to the present embodiments can improve the positive electrode manufacturing process while not considerably affecting the battery performance, it can be advantageously used in manufacturing large-capacity batteries.

Although the present embodiments have been described with reference to certain example embodiments thereof, it will be understood by those skilled in the art that a variety of modifications and variations may be made to the present embodiments without departing from the spirit or scope of the present embodiments defined in the appended claims, and their equivalents.

What is claimed is:

1. A positive electrode slurry composition for a lithium secondary battery, comprising:
a nickel (Ni) based positive active material;
a binder; and
an inorganic additive.

2. The positive electrode slurry composition of claim 1, wherein the inorganic additive is at least one selected from the group consisting of ZnO, TiO₂, SnO₂, Al₂O₃, In₂O₃, SiO₂, WO₃, and V₂O₅.

3. The positive electrode slurry composition of claim 1, wherein the inorganic additive is V₂O₅.

4. The positive electrode slurry composition of claim 1, wherein the inorganic additive is from about 0.01 wt % to about 5 wt % of the positive electrode slurry composition.

5. The positive electrode slurry composition of claim 1, wherein the nickel (Ni) based positive active material is selected from the group consisting of materials represented by formulas (1) to (7):
LiₓNi_{1-y}M_{y}A₂ (1)
LiₓNi_{1-y}M_{y}O_{2-z}X_{z} (2)
LiₓNi_{1-y}Co_{y}O_{2-z}X_{z} (3)
LiₓNi_{1-y-z}Co_{y}M_{z}A_{α} (4)
LiₓNi_{1-y-z}Co_{y}M_{z}O_{2-α}X_{α} (5)
LiₓNi_{1-y-z}Mn_{y}M_{z}A_{α} (6)
LiₓNi_{1-y-z}Mn_{y}M_{z}O_{2-α}X_{α} (7)
wherein 0.9≦x≦1.1, 0≦y≦0.5, 0≦z≦0.5, 0≦α≦2, M is selected from the group consisting of Mg, Al, Co, K, Na, Ca, Si, Ti, Sn, V, Ge, Ga, B, As, Zr, Mn, Cr, Fe, Sr, V and rare-earth elements, A is selected from the group consisting of 0, F, S and P, and X is selected from the group consisting of F, S and P.

6. The positive electrode slurry composition of claim 1, wherein the positive active material further comprises a conductive agent.

7. The positive electrode slurry composition of claim 6, wherein the conductive agent is one selected from the group consisting of natural graphite, artificial graphite, carbon black, acetylene black, ketjen black, carbon fiber, metal powder, copper fiber, nickel fiber, aluminum fiber, silver fiber, polyphenylene derivatives, or combinations thereof.

8. A lithium secondary battery comprising:
a positive electrode comprising a positive electrode slurry composition comprising: a nickel (Ni) based positive active material; a binder; and an inorganic additive; and
a negative electrode including a negative active material capable of intercalating/deintercalating lithium ions; and
an electrolyte.

9. The lithium secondary battery of claim 8, wherein the inorganic additive is at least one selected from the group consisting of ZnO, TiO₂, SnO₂, Al₂O₃, In₂O₃, SiO₂, WO₃, and V₂O₅.

10. The lithium secondary battery of claim 8, wherein the inorganic additive is V₂O₅.

11. The lithium secondary battery of claim 8, wherein the inorganic additive is from about 0.01 wt % to about 5 wt % of the positive electrode slurry composition.

12. The lithium secondary battery of claim 8, wherein the nickel (Ni) based positive active material is selected from the group consisting of materials represented by formulas (1) to (7):
LiₓNi_{1-y}M_{y}A₂ (1)
LiₓNi_{1-y}M_{y}O_{2-z}X_{z} (2)
LiₓNi_{1-y}Co_{y}O_{2-z}X_{z} (3)
LiₓNi_{1-y-z}Co_{y}M_{z}A_{α} (4)
LiₓNi_{1-y-z}Co_{y}M_{z}O_{2-α}X_{α} (5)
LiₓNi_{1-y-z}Mn_{y}M_{z}A_{α} (6)
LiₓNi_{1-y-z}Mn_{y}M_{z}O_{2-α}X_{α} (7)
wherein 0.9≦x≦1.1, 0≦y≦0.5, 0≦z≦0.5, 0≦α≦2, M is selected from the group consisting of Mg, Al, Co, K, Na, Ca, Si, Ti, Sn, V, Ge, Ga, B, As, Zr, Mn, Cr, Fe, Sr, V and rare-earth elements, A is selected from the group consisting of 0, F, S and P, and X is selected from the group consisting of F, S and P.

13. The lithium secondary battery of claim 8, wherein the positive active material further comprises a conductive agent.

14. The lithium secondary battery of claim 13, wherein the conductive agent is one selected from the group consisting of natural graphite, artificial graphite, carbon black, acetylene black, ketjen black, carbon fiber, metal powder, copper fiber, nickel fiber, aluminum fiber, silver fiber, polyphenylene derivatives, or combinations thereof.

15. A method of making a lithium secondary battery, the method comprising:
preparing positive electrode slurry for forming the positive electrode slurry composition comprising: a nickel (Ni) based positive active material; a binder; and an inorganic additive, comprising the steps of:
adding the inorganic additive to the positive electrode slurry composition including the nickel (Ni) based positive active material, the binder, and the solvent;
coating the positive electrode slurry on at least one surface of a positive current collector; and
manufacturing a positive electrode by drying and pressing the coated positive electrode slurry.

16. The method of claim 15, wherein the inorganic additive is at least one selected from the group consisting of ZnO, TiO₂, SnO₂, Al₂O₃, In₂O₃, SiO₂, WO₃, and V₂O₅.

17. The method of claim 15, wherein the inorganic additive is V₂O₅.

18. The method of claim 15, wherein the inorganic additive is from about 0.01 wt % to about 5 wt % of the positive electrode slurry composition.

19. The method of claim 15, wherein the nickel (Ni) based positive active material is selected from the group consisting of materials represented by formulas (1) to (7):
LiₓNi_{1-y}M_{y}A₂ (1)
LiₓNi_{1-y}M_{y}O_{2-z}X_{z} (2)
LiₓNi_{1-y}Co_{y}O_{2-z}X_{z} (3)
LiₓNi_{1-y-z}Co_{y}M_{z}A_{α} (4)
LiₓNi_{1-y-z}Co_{y}M_{z}O_{2-α}X_{α} (5)
LiₓNi_{1-y-z}Mn_{y}M_{z}A_{α} (6)
LiₓNi_{1-y-z}Mn_{y}M_{z}O_{2-α}X_{α} (7)
wherein 0.9≦x≦1.1, 0≦y≦0.5, 0≦z≦0.5, 0≦α≦2, M is selected from the group consisting of Mg, Al, Co, K, Na, Ca, Si, Ti, Sn, V, Ge, Ga, B, As, Zr, Mn, Cr, Fe, Sr, V and rare-earth elements, A is selected from the group consisting of 0, F, S and P, and X is selected from the group consisting of F, S and P.

20. The method of claim 15, wherein the positive active material further comprises a conductive agent.
